(19) United States
(12) Patent Application Publication
(10) Pub. No.: US 2019/0373680 A1
(43) Pub. Date: Dec. 5, 2019

(54) FILM HEATER AND METHOD OF MAKING

(71) Applicant: GENTHERM GMBH, Odelzhausen (DE)

(72) Inventors: Jack Barfuss, Windsor (CA); Martin Schaetzle, Odelzhausen (DE); Michael Weiß, Odelzhausen (DE); Regina Hanslmeier, Odelzhausen (DE); Denise Philipp, Odelzhausen (DE)

(21) Appl. No.: 16/461,854

(22) PCT Filed: Nov. 16, 2017
(86) PCT No.: PCT/US2017/061931

§ 371 Date: May 17, 2019

Related U.S. Application Data
(60) Provisional application No. 62/425,521, filed on Nov. 22, 2016.

(51) Int. Cl. H05B 3/14; H05B 3/34; H05B 3/82

(52) U.S. Cl. CPC H05B 3/145; H05B 3/34; H05B 3/82; H05B 2203/003; H05B 2203/016; H05B 2203/017; H05B 2203/02; H05B 2203/029; H05B 2203/013

(57) ABSTRACT

A heater comprising: (a) a film; (b) one or more coverings that extends along one or more sides of the film; and (c) one or more power application portions that apply power to the film so that the film heats up; wherein the film is a graphite film.

### FIELD

The present teachings generally relate to a film heater and preferably a synthetic graphite film heater and a method of making the same.

### BACKGROUND

The present teachings are predicated upon providing an improved heater and more preferably an improved heater for use in a vehicle. Generally, heaters include a wire that is formed in a pattern. The wire produces heat when electricity is applied to the wire. The wire may also be placed in a carbonaceous material so that as the wire heats up the heat is diffused into the carbonaceous material heating a larger area. However, achieving uniform heating in these devices may not always be achieved and hot spots may occur around the heating wires. Further, if a heating wire breaks the heater may cease to heat. Heaters may also include electrodes that are connected by a positive temperature coefficient material so that electricity is conducted from one electrode through the positive coefficient material to the other electrode and heat is produced. Other heaters have a woven configuration where a plurality of long materials are woven together to form a heater. These heaters may result in hot spots along one or more of the long materials as these materials may allow for current drift along one wire. Attempts have been made to create film heaters by connecting a film directly to a rigid surface to be heated so that the rigid surface to be heated supports the film heater. Examples of heaters may be found in U.S. Pat. Nos. 5,824,996; 6,057,530; 6,150,642; 6,172,344; 7,053,344; and 7,838,804; U.S. Patent Application Publication Nos. 2003/155347; 2004/0211772; 2007/0278210; 2010/0200558; and 2010/0282458; European Patent No. EP2400814; German Patent Application No. DE102004025033; and Japanese Patent Publication No. JP02-120039 all of which are incorporated by reference herein for all purposes. However, these systems may include

It would be attractive to have a heater with a high degree of flexibility to conform to an occupant and to avoid crinkling noises or the like in response to occupant motion. It would be attractive to minimize part quantities in an assembly and correspondingly to reduce assembly steps. Notwithstanding what exists today, car manufacturers and others continue to seek low cost, light weight, and easy to manufacture ways to provide a heating surface. In this regard one attractive feature is to be free of dependency upon fluctuating prices for high demand metals such as gold, silver, copper, or the like. It would be attractive to avoid dependency of adhesive bonding of conductive metals to a surface.

What is needed is a flexible seat heater that is free of and/or substantially free of gold, silver, and copper. It would be attractive to have a heater that may be subjected to a flexing action without partial or complete failure of all or a portion of the heater. It would be attractive to have a heater that is highly resistant to liquids, acids, and bases. It would be attractive to have a heater that is impervious to humidity. What is further needed is a flexible seat heater that may be cut, bent, shaped, formed, or a combination thereof without losing any heating functions. What is needed is a heater that is very thin so that read through is minimized in occupant contact zones.

### SUMMARY

The present teachings meet one or more (if not all) of the present needs by providing: a heater comprising: (a) a film; (b) one or more coverings that extends along one or more sides of the film; and (c) one or more power application portions that apply power to the film so that the film heats up; wherein the film is a graphite film.

The present teachings provide a method comprising: connecting a covering to a first side of a film; (a) attaching one or more power application portions to the film; (b) folding a tab of the one or more power application portions from a first side of the film to a second side of the film so that a heater is formed; (c) cutting the film, the covering, or both; wherein the film is a graphite film that when power is supplied heats up.

The teachings herein surprisingly solve one or more of these problems by providing a flexible seat heater that is free of and/or substantially free of gold, silver, and copper. The present teachings provide a heater that may be subjected to a flexing action without partial or complete failure of all or a portion of the heater. The present teachings provide a heater that is highly resistant to liquids, acids, and bases. The present teachings provide a heater that is impervious to humidity. The present teachings provide a flexible seat heater that may be cut, bent, shaped, formed, or a combination thereof without losing any heating functions. The present teachings provide a heater that is very thin so that read through is minimized in occupant contact zones.

### BRIEF DESCRIPTION OF THE DRAWINGS

FIG. 1A illustrates a film of a foil heater;

FIG. 1B is a stencil for cutting the film of FIG. 1A;

FIG. 1C is the stencil of FIG. 1B overlaying the film of FIG. 1A;

FIG. 1D is a cut film in a laminator;

FIG. 1E illustrates electrodes being applied to the film;

FIG. 1F illustrates the flexibility of the foil heater of FIG. 1E;

FIG. 1G is a thermal image of the foil heater of FIG. 1E;

FIG. 2A is a front view of an assembly device that is assembling foil heaters of the teachings herein;

FIG. 2B is a rear view of the assembly device of FIG. 2A;

FIG. 3A is a pattern for a die;

FIG. 3B is the pattern of FIG. 3A cut into a die;

FIG. 3C illustrates a blade installed into the die of FIG. 3B forming a cutter;

FIG. 4 is a cross-sectional view of a heater;

FIG. 5A illustrates a heater including slits;

FIG. 5B illustrates a heater including slits;

FIG. 5C illustrates a heater including slits;

FIG. 5D illustrates a heater including slits;

FIG. 5E illustrates a heater including slits;

FIG. 5F illustrates a heater including slits;

FIG. 5G illustrates a heater including slits;

FIG. 5H illustrates a heater including slits;

FIG. 5I illustrates a heater including slits;

FIG. 5J illustrates a heater including slits;

FIG. 6A illustrates a cross section of a rivet;

FIG. 6B illustrates an upper terminal plate;

FIG. 6C illustrates a lower terminal plate;

FIG. 6D illustrates a connection device including a wire;

FIG. 6E illustrates an exploded view of a power application portion being connected to a heater;

FIG. 6F illustrates a power application portion of FIG. 6E connected to a heater;

FIG. 7 is an atomic structure of the film;

FIG. 8 illustrates a top view of a heater;

FIG. 9 illustrates a top view of a heater;

FIG. 10 is a top view of a power application portion; and

FIG. 11 is a top view of a power application portion.

### DETAILED DESCRIPTION

The explanations and illustrations presented herein are intended to acquaint others skilled in the art with the invention, its principles, and its practical application. Those skilled in the art may adapt and apply the teachings in its numerous forms, as may be best suited to the requirements of a particular use. Accordingly, the specific embodiments of the present teachings as set forth are not intended as being exhaustive or limiting of the teachings. The scope of the teachings should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. Other combinations are also possible as will be gleaned from the following claims, which are also hereby incorporated by reference into this written description.

The device as taught herein may be useful as a heater and/or incorporated into another device so that the other device may be used as a heater. The device as taught herein may be used for any known heating application. For example, the heater may be used to heat a bed, plants, be a therapeutic heater, vehicle seats, steering wheels, mirrors, glass, flooring, bolster, armrest, headrest, shift knob, dashboard, door, ceiling, or a combination thereof. Preferably, the device as taught herein may be connected to, incorporated into, or both a vehicle seat and/or the vehicle seat may include the composition taught herein so that a vehicle seat may be heated. The heater as discussed herein may be a discrete piece that is laid over a cushion of a vehicle seat (i.e., bun or back portion) and then a trim cover is placed over the heater. The heater may be shapeable, formable, cuttable, slittable, or a combination thereof so that heater may be substantially prevented form heating the trench regions of a vehicle seat. A trim cover may have attachment features that extend through the heater so that the heater is connected to the trim cover and substantially extends over the trench while the attachment features act to secure both the trim cover and the heater to the seat.

The heater may be secured in the vehicle seat by a mechanical fastener, an adhesive, pressure from one or more adjacent layers, or a combination thereof. The heater may be secured directly to the trim layer, the cushion (i.e., bun, back, or both) of the seat, or a combination of both. The heater may be secured to a comfort layer. For example, a comfort layer may be added between the trim layer and the cushion so that an passenger sensor, heater, insert (e.g., for cooling), or a combination thereof may be felt by an occupant. The occupant layer may be foam, fleece, or both that prevents an occupant from feeling layers between the trim layer and cushion. A mechanical fastener may extend through, connect to, attach on, or a combination thereof the heater so that the heater may be fixed within the seat. The mechanical faster may be a plastic tag that is punched through the heater and a portion of the seat and/or trim layer so that a fixed connection is formed. The mechanical fastener may be a hog ring, a metal bar that extends over a portion of the heater and pulls the heater, the trim layer into close proximity to the cushion, or both. The heater of the teachings herein may be used in conjunction with other devices.

The heater may be used with a passenger sensor. The heater may be placed over and/or under a passenger sensor. The heater may both provide heat and be used as a sensor. The passenger sensor may be any type of passenger sensor that senses the presence of a passenger. The passenger sensor may be a capacitive sensor, a pressure sensor, a membrane sensor, infrared, passive and/or active ultrasonic sensor, a mass sensor, or a combination thereof. The heater and a passenger sensor may be used with an active cooling system, active heating system, a ventilated system, or a combination thereof.

The heater may be used with an active heating system, active cooling system, ventilation system, or a combination thereof. The heater may include one or more porous layers, slits, holes, or a combination thereof that cover the heater so that air passes directly through the heater and the one or more layers that cover the heater (e.g., a fleece layer, an adhesive, a protective covering layer, or a combination thereof). The heater, film, or both may be free of holes. The heater, film, or both may include holes. The holes may be any shape so that heat is created and the adjoining surface, person, item, device, or a combination thereof is heated. The holes may be round, oval, square, cross-like, long and thin, symmetrical, asymmetrical, geometric, non-geometric, or a combination thereof. The heater, film, or both may include side cutouts. Preferably, the heater, film, or both may be free of side cutouts. The heater, film, or both may be serpentine in shape. Preferably, the heater is not serpentine in shape, but the film is serpentine in shape. The film may be “U” shaped, include a “U” shaped portion, be “S” shaped, include an “S” shaped portion, have a portion that is undulating, concentric circles, be substantially square shaped, have two halves that are a mirror image of each other; include a portion that is circular, have a portion that is wave-like (e.g., sine wave), rounded, elliptical, wavy, or a combination thereof. The segments of the heater may be separated by holes, slits, or both. The holes, cutouts, or both may be removal of material. The slits may be a cutting of material without removal of any material. Slits may remove material.

The slits may function to introduce flexibility into a heater (i.e., film, upper covering, lower covering, or a combination thereof). The slits may extend in virtually any direction. The slits may extend lengthwise, longitudinally, at an angle, slits may cross each other, the slits may be free of contact with other slits, the slits may form a “+” sign, may form a “‡”, the slits may vary is thickness, the slits may be a cut in the material without removing any material, the slits may be interconnected, the slits may extend in straight lines, the slits may be arcuate, the slits may be linear, the slits may curve, the slits may bend, or a combination thereof. The slits may be interconnected. The slits may be two interconnected plus signs. The slits may mirror the shape of the film. The slits may extend through the covering and mirror the shape of the film. The slits may be free of extending through the film. The heater may include one or more covers that fully and/or partially cover the heater so that the cover assists in directing fluid flow to regions of the heater that may be contacted. The one or more covers when present may be formed in any configuration so that air may be directed to specific desired locations. For example, the heater may be substantially porous through a central “U” shaped portion of the heater and the regions surrounding the “U” shape may include a non-porous or barrier material that may prevent a fluid from passing so that the fluid moved is directed to the contact areas. The heater may include one or more through holes so that air may be moved through the heater. The heater may include and/or be in fluid communication with a fan and/or blower, be adjacent to a blower and/or fan so that the blower and/or fan may move a fluid through and/or around the heater. The heater, the fan, the blower, or a combination thereof may include a peltier device, a thermoelectric device, or both so that hot and/or cooled air (i.e., conditioned air) may be moved towards an occupant. The heater may be indirectly connected to a fan, blower, or both that include a peltier device, a thermoelectric device, or both.

The heater may be connected to an insert (i.e., bag) that assists in distributing conditioned air to an occupant. The heater may have one or more holes or slits that mirror the holes in the insert. The heater may have no holes and the air from the bag may pass directly through the heater in route to an occupant. The heater layer may be connected directly to the insert. All or a portion of the heater layer may be connected to the insert. The insert may be one or more polymeric layers that form a substantially air impermeable layer and/or an air impermeable layer so that air directed into the insert is directed to a predetermined region. The insert may include one or more spacer materials. The heater as taught herein may act as the spacer material and/or part of a spacer layer that forms an open space in the insert. For example, the spacer layer may be half the height of a standard spacer and the heater may make up the other half of the spacer layer so that air may be distributed throughout the open space formed in the insert.

The heater may include a heating layer that is a film. The heater may be a heater film that is covered by one or more covering layers (e.g., an upper covering, a lower covering, or both). The film of the heater may be the layer that produces heat. The film may be formed as a sheet. Preferably, the film as taught herein is a nonwoven sheet. The film may be made of any nonwoven material that conducts electricity and produces heat. The film may be made of any nonwoven material that may be cut, bent, folded, pierced, or a combination thereof and produce heat when power is applied. The material of the heating layer (i.e., film) possess a thickness. The thickness of the heating layer may be any thickness so that upon application of power the heating layer produces heat. The heating layer may be sufficiently thin so that the resistivity is from about 2 Ω-square to about 8 Ω-square and preferably from about 3 Ω-square to about 7 Ω-square and heating performance of the heating layer is improved when compared to heating layer lower than the heating layer taught herein. The thickness of the heating layer may be about 0.001 mm or more, about 0.005 mm or more, or preferably about 0.01 mm or more. The thickness of the heating layer may be about 3 mm or less, about 1 mm or less, about 0.5 mm or less, preferably about 0.25 mm or less, more preferably about 0.2 mm or less, or more preferably about 0.15 mm or less. The thickness of the heating layer may be between about 0.001 mm and about 1 mm, preferably between about 0.005 mm and about 0.8 mm, and more preferably between about 0.1 mm and about 0.2 mm.

The heater layer or film may function to produce heat upon power being introduced into the heater layer or film. The heater layer includes carbon. The heater layer may be self-supporting. The heater layer may be free of a substrate that the heater layer is formed on or that carriers the heater for the heater to function. For example, the heater layer may be free of an additional material that does not assist in producing heat and is only present to support the heating layer or for the heating layer to be formed upon. The heater layer may be made of a homogeneous material. The heater layer may be comprised primarily of carbon. The heater layer may include about 70 percent by weight carbon or more, about 80 percent by weight carbon or more, about 85 percent by weight carbon or more, about 90 percent by weight carbon or more, preferably about 95 percent by weight carbon, more preferably about 99 percent by weight carbon or more, or even more preferably about 100 percent by weight carbon or more. The heater layer may comprise substantially about 100 percent by weight carbon in the form of graphite. The carbon may be powder that is compressed into flakes. The carbon may be flakes that are compressed into plates or layers. The plates may be pressed into a foil or a film. The atomic structure of the graphite film may be one or more, preferably two or more, more preferably three or more, or even more preferably four or more layers stacked together. Preferably, the carbon of the film is in its atomic structure and the carbon layers are covalently bonded together. The heater layer may be free of adhesive to connect carbon atoms or carbon layers together. The heater layer may include an adhesive that may bond the heater structure together, bond one or more layers together, form a protective layer over one or more layers, or a combination thereof. The carbon may be a crystalline graphite that is pressed into flakes, a foil, plates, a film, or a combination thereof. The graphite may be formed by pyrolysis, naturally occurring, synthetically, or a combination thereof. The carbon may be heated while being pressed. The carbon may extend into an acid bath before, during, or after formation of the film. The acid soaked carbon may be heated and broken apart into expanded flakes, or plates. The film may be a plurality of layers of carbon plates or flakes. The carbon flakes or layers may be heated so that the flakes or layers bond together. The film may be two or more, three or more, or even four or more layers of graphite plates, flakes, or both. The plates, flakes, or both may be aligned in a machine direction, a cross machine direction, or both. The flakes, plates, or both may be randomly oriented. The flakes, plates, or both may square within the film. For example, the plates, flakes, or both may extend both in the machine direction and the cross-machine direction so that there is no prevalent direction that the plates, flakes, or both extend. The film may be substantially free of adhesive. The film may be free of any binders that hold the film together. The film may include covalently bonded carbon plates, flakes, or both. The carbon, graphite, or both within the film may be covalently bonded together.

A heating layer as discussed herein has a resistivity and a surface power density. The heating layer may be sufficiently thick, wide, or long so that the resistivity is sufficiently high so that the heating layer becomes hot when power is applied. For example, as the heating layer becomes thicker the resistivity will go down and as the heating layer becomes longer the resistivity will go up. The resistivity of the heating layer may be about 1 Ω-square or more, preferably about 2.5 Ω-square or more, more preferably about 4 Ω-square or more, or more preferably about 5 Ω-square or more. The resistivity of the heating lay may be about 20 Ω-square or less, about 15 Ω-square or less, about 10 Ω-square or less, or about 8 Ω-square or less (i.e., from about 4 Ω-square to about 6 Ω-square (e.g., about 5.2 Ω-square with an application of 750 W/m² at 13.5 V).

The surface power density of the heating layer may be about 100 W/m² or more, about 200 W/m² or more, about 300 W/m² or more, or about 400 W/m² or more. The surface power density may be about 2000 W/m² or less, about 1500 W/m² or less, about 1000 W/m² or less, or about 750 W/m² or less (i.e., from about 600 W/m² to about 450 W/m²).

The heater layer may be any carbon containing compound that: heats up when electricity is added to the heating layer; exhibits PTC (i.e., positive temperature coefficient) characteristics (e.g., may self-regulate); is resistant to burning, flame, or both; is durable and can resist being bent, flexed, folded, or a combination thereof a plurality of times, is resistant to read through; or a combination thereof. The material of the heating layer may include have resistance to chemicals. Generally, the material of the heating layer may exhibit one or more of the following resistances to chemicals and/or material characteristics. The material of the heating layer may have good resistance to strong acids. The material of the heating layer may have excellent resistance to weak acids. The material of the heating layer may have poor resistance to strong bases. The material of the heating layer may have good resistance to weak bases. The material of the heating layer may have excellent chemical resistance to organic solvents. The material of the heating layer may exhibit a low modulus of elasticity (i.e., the material does not stretch), non-abrasive, non-hardening, self-lubricating, or a combination thereof. Good resistance to a material means that the heater layer does not delaminate, disintegrate, chemically reverse bonding, or a combination thereof. Therefore, good resistance to a material means that the heating layer continues to function, produce heat, and maintains its structural integrity. The material of the heating layer may be covered on one or both sides by one or more covering layers.

The one or more covering layers may function to support the film. The covering may function as a reinforcement for the film, a protectant, or both. The one or more covering layers may function to prevent the film from stretching, tearing, breaking, folding, wrinkling, or a combination thereof. The one or more covering layers may not be a substrate and may be added after the heater layer is formed. The one or more covering layers may function to keep the film planar. Preferably, the one or more covering layers are a plurality of covering layers. The one or more covering layers may be adhered to the film. Preferably, a sheet of covering is located on a first side (e.g., an upper covering) and a second side (e.g., a lower covering) of the film so that the film is protected from contact with the environment (e.g., fluids, humidity) and physical damage. The one or more covering layers may be sealed around edges of the film. The one or more covering layers may seal at any location where a covering opposes another covering. For example, a covering on a first side when contacts a covering on a second side forms a seal or a connection. A slit may extend through a seal or connection without breaking the seal. The one or more covering layers may be slit in a manner discussed herein as to the heating layer such that the covering layer and the heating layer are substantially identical. The slits may be added after the covering layers are added to the heating layer so that the slits extend through two or more layers. The seal may be formed by adhesive, lamination (hot or cold), melting, welding, heat staking, ultrasonic welding, or a combination thereof. The one or more covering layers may prevent fluids, humidity, or both from contacting the film or entering the heater. The one or more covering layers may be a thermoplastic polymer film. The one or more covering layers may be made of or include plastic, polyurethane, Mylar®, Tedlar®, polyvinylchloride, polypropylene, polyethylene, polystyrene, nylon, a polyamide, vinyl, acetate, elastane, Spandex®, Lycra®, polyether-polyurea copolymer, or a combination thereof. The one or more covering layers may be a fleece. The one or more covering layers may prevent stretching of the heater film. The one or more covering layers may permit stretching of the heater without damage to the heater. For example, the heater may be laminated between two covering layers with elastomeric characteristics and the covering layers may be slit so that the heater and covering layers may be stretched without damage to the heater film. The one or more covering layers may be laminated together. The covering layers may sandwich the film. A single covering layer may be used and the single covering layer may be folded so that the film is located therebetween. The covering layer may extend along only one side of the film. The one or more covering layers may have a thickness of about 1 mm or more, about 2 mm or more, or about 3 mm or more. The covering layer may have a thickness of about 1 cm or less, about 7 cm or less, or about 5 cm or less. The covering layer may assist in attaching one or more power application portions to the heater.

The heater may include power application portions (e.g., electrodes). The heating layer may be attached to at least two power application portions and upon application of electricity (e.g., power) the heating layer produces heat. The heating layer when connected to a positive power source and a negative power source (i.e., power application layers) may produce heat. Preferably, the heating layer is free of terminals that connect to busses and/or electrodes to the heating layer. For example, the heating layer is directly connected to the power application portions via one or more tabs (e.g., terminal). The terminal may directly and/or indirectly attach to the heating layer using any device so that electricity enters the heating layer through the terminals and the heating layer produces heat. The terminals may be crimped or adhered onto the heating layer. For example, the power applications may include terminals or tabs that connect a power source to the power applications. The terminals may be connected by sewing, bonding, gluing, adhering, a mechanical fastener, locking the terminals between one or more layers, a rivet, or a combination thereof to the heating layer, each power application layer, or both. The heater may be free of mechanical fasters that attach a power source to the heater. For example, the heating layer may not have a mechanical attachment device that grips the heating layer and secures one or more wires to the heater. The heating layer may include two or more power applications that assist in supplying power to the heating layer.

The two or more power applications may be located at any location on the heater. Preferably, the two or more power applications are spaced apart. The two or more power applications may be spaced a sufficient distance apart so that the heater is partially and/or entirely energized upon an application of power. More preferably, the two or more power applications are located in an edge region or a terminal end region of the heater. For example, one power application may be located along one edge or at one terminal end of the heater and a second power application may be located along the opposing edge or a second terminal end so that power travels through the heater as the power travels from the first edge or terminal end to the second edge or terminal end. The power application portions may be located at ends or in end regions of the heater layer. The power application portions may be spaced apart by the entire heating layer. For example, if the heating layer is serpentine in shape the power application portions may be located electrically on opposite ends, although physically the power application portions may be adjacent to one another. Each power application portion may include one or more parts for applying power. The power application portions may include an upper terminal plate, a lower terminal plate, rivet, wires, tabs, adhesives, connections, attachment devices, or a combination thereof.

The heater may include a rivet that extends through one or more layers. The rivet may extend through one or more holes that are punched in a heater layer. The holes may be created with a punch press, but may be formed at the same time the heater is formed. The rivet may extend through the covering, the film, or both. The rivet may be connected to one or more wires. The rivet may be connected to one or more terminal plates, attachment devices or both. The rivet may hold one or more terminal plates, one or more attachment devices or both in place, in contact with the film, a tab, or both.

The one or more terminal plates, (e.g., upper terminal plate and lower terminal plate) may be located on the first side, second side, or both sides of the film, heater, or both. The one or more terminal plates may prevent the rivet from being pulled through the heater. The one or more terminals may provide power or an electrical connection to the film. The one or more terminal plates may be an attachment device. The attachment device may be connected to one or more wires so that power is applied to the film and the film heats up. The attachment device may be a terminal plate that is connected to the wire. The attachment device and wire may be connected via solder, conductive adhesive, welding, a mechanical connection, crimping, or a combination thereof. The attachment device may be placed on the rivet before the rivet is connected to the heater. The attachment device may be connected to the rivet via a fastener, adhesive, or a combination thereof. The attachment device may provide an electrical path between the power source and wire and the film. The attachment device may be covered by one or more patches after the attachment device, the wires, or both are connected to a heater layer. The one or more patches may be a barrier layer, a fleece, upper barrier layer, lower barrier layer, or a combination thereof. The one or more patches may be added over or under an upper barrier layer or a lower barrier layer. The one or more patches may extend over one or more terminals. Preferably, the attachment device is in communication with a tab and the tab provides power to the film.

The one or more tabs function to transfer power from the wire, attachment device, or both to the film. The one or more tabs may extend around one or more layers of the heater. The one or more tabs may extend on a first surface of a layer where the tab is in communication with the wire or attachment device and to a second surface of the layer where the tab is in communication with the film. For example, the tab may be generally “C” shaped and may be folded around a cover so that power follows the path of the tab from an outside of the heater and into the heater so that power is transferred to the film. The one or more tabs may be a conductive material. The one or more tabs may be metal. The one or more tabs may be, include, or be coated with copper, gold, silver, steel, tungsten, titanium, aluminum, nickel, or a combination thereof. Preferably, the one or more tabs are connected to one layer. The one or more tabs may be connected to a plurality of layers. The tabs may have a first surface that faces both the film and the attachment device. The tabs may have a second surface that faces both the top and the bottom of a covering layer. The tab may have a first surface that faces the attachment device and a second surface that faces the film so that power enters through the first surface and exits the second surface. The one or more tabs may be connected via one or more attachment layers.

The heater may include one or more attachment layers. The attachment layer may be a single sided adhesive layer or a two sided adhesive layer. The attachment layer may be made of the same material as the adhesive discussed herein for attaching the power applications. The attachment layer may be an adhesive layer (e.g. a glue, paste, spray on adhesive, an adhesive film, a peel and stick, hook and loop, or the like). Preferably, the attachment layer may be a peel and stick film. The adhesive may be a conductive glue. The adhesive may include a thermoset powder. The thermoset powder may prevent re-melting, softening, liquification, or a combination thereof of the adhesive one the adhesive is applied, dried, forms a bonded connection, or a combination thereof. The thermoset powder may be present in a sufficient amount so that the adhesive does not soften or melt during the heater producing heat. The thermoset powder may be present in an amount of about 5 percent or more, about 10 percent or more, about 15 percent or more, or about 20 percent or more of the total mass of the adhesive. The thermoset powder may be present in an amount of about 60 percent or less, about 40 percent or less, or about 30 percent or less of the total mass of the adhesive. The thermoset powders may include epoxy, hydroxyl or carboxyl, acrylic, silicone groups, or a combination thereof. The thermoset powders may be crosslinked with a reactive acid polyester to form a blend or hybrid material. The thermoset powders may form crosslinking when cured. The thermoset powders may be epoxy, polyurethane, phenolic, or a combination thereof. The attachment layer may mirror the size and shape of the tabs. The attachment layer may connect the tabs to the covering layers, the film, or both. The attachment layer may exhibit protection characteristics as discussed herein. The heater may be free of an attachment layer.

The heater (e.g., heating layer (i.e., film), forward cover layer, rearward cover layer, adhesive layers, attachment layers, or a combination thereof) as discussed herein may have a high fold resistance. The heater may have sufficient fold (e.g., bend resistance with a 5 mm radius) resistance so that the heater when placed in a seat may withstand wear for about 5 years or more, preferably about 7 years or more, or more preferably use for 10 years or more. The heater may have sufficient fold resistance that the heater may withstand 50,000 cycles or more, preferably 100,000 cycles or more, or more preferably about 200,000 cycles or more in the Z-direction without the heater losing any function.

The heater as discussed herein may be produced using a process. The process may include one or more of the following steps produced in virtually any order. One or more rolls over covering may be loaded into a device. The one or more rolls may include an upper covering and a lower covering. The device may extend the lower covering, the upper covering, or both. One or more tabs may be connected to the lower covering, the upper covering, or both. The tabs may be connected to the lower covering, the upper covering, or both at a single locations. The film may be placed on the lower covering, the upper covering, or both. The film and upper covering, lower covering, or both may be advanced to a folding station. The folding station may fold the tab so that one surface of the tab is in communication with the film. The one or more tabs may be adhered to the film; a first surface of a covering (e.g., upper covering or lower covering); a second surface of a covering; or a combination thereof. The adhesive may be applied when the tab is applied, when the tab is folded, or both. The tab applicator, folder, or both may apply the adhesive. The adhesive may be on the tab. A rivet may extend through the heater, the tabs, or both. One or more terminal plates, attachment devices, or both may be connected to a wire. The one or more terminal plates, attachment devices, or both may be connected to a rivet. The one or more terminal plates, attachment devices, or both may be connected to a first side, a second side, or both sides of the heater, covering, film, or a combination thereof. A peel and stick layer may be removed from the tab so that the tab is secured. The folder may fold a covering layer over so that the covering layer extends on both a first surface and a second surface of the film. The film may be cut before the film is added, after the film is added, during the addition of the film, during the addition of the tabs, when the tabs are folded, or a combination thereof. The one or more coverings, heater, film, or a combination thereof may be cut, slit, or both. The process may include a step of cutting and slitting at the same time. The process may include using a cutter that cuts and slits at the same time. The cutting device may include a stencil, a blade, a cutter, or a combination thereof.

The cutting device and cutter may be stamped on the heater to cut the heater, cut the slits, or both. The cutting device may have blades that cut and slit at standard locations. The cutting device may separate individual heaters from a roll and then the slits may occur. The cutting device may be a guillotine style cutter. The cutting device may include one or more die cutters. The heater may have a primary cut and a secondary cut. For example, the heater may be cut from the roll in a first cut and slit in a second cut or vice versa. The cutting device may use stripping blades that cut edges or pieces from the film to create regions that are not heated. The cutting device may be a laser that cuts the film, the heater, or both. The cutting device may be a plasma cutter. The cutter may trace a stencil.

The one or more stencils may function to take a standard heater and covert the heater for a specific application. The stencils may provide placement for slits. The stencils may prevent the film from being damaged due to stamping of the cutter. The stencils may provide an outline for a robot to follow. The stencils may include stencil slits representing where the slits in the blades in the die, the slits in the heater, or both may be present. The stencils may be used to create a die, a blade, a cutter or a combination thereof.

The die may function to create a cutter. The die may be a positive so that a negative may be formed or vice versa. The die may include projecting portions for cavities in a cutter that receive one or more blades. The die may be formed using the stencil. The die may hold the blades and be moved to cut, slit, or both the heater, the coverings, or both. The die may include one or more cavities. The cavities may hold one or more blades. The cutter may be integrated into a cutting device for cutting, slitting, or both the heaters form a roll.

As discussed herein the heater may be integrated into another component during the construction of the component so that the heater and the component form one unitary piece. For example, if the article is a molded part the heating medium, which forms the heating layer, may be added into the mold so that when a final article is created the heater layer is throughout the article and the entire article heats when electricity is added. The heating medium may be a sheet or film. The heating medium may be cut and placed in the mold as a sheet, mixed into the molding material and both materials added to a mold together, or a combination thereof.

The heater a discussed herein may be controlled using any method discussed herein. Preferably, the heater include a thermistor or a negative coefficient temperature sensor that measures the temperature of the heater and based upon the measured temperature a controller controls the temperature of the heater, the ventilation system, the conditioning system, or both. The heater, the conditioning system, the ventilation system, or both may be controlled using pulse width modulation.

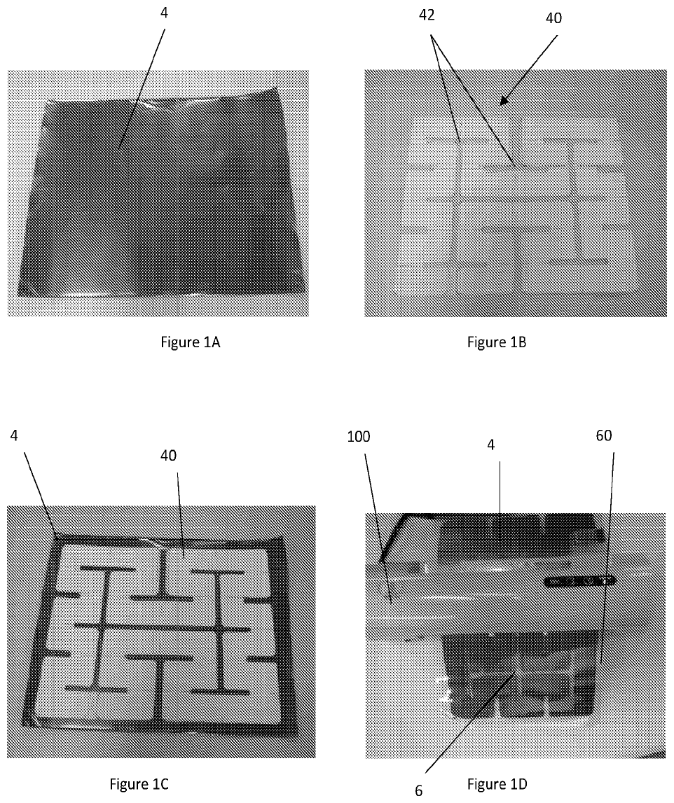

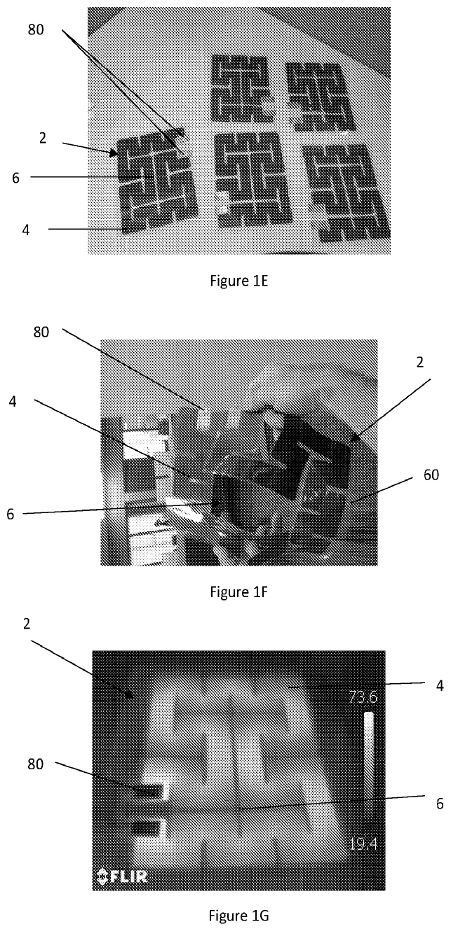

FIG. 1A illustrate a film 4 of the teachings herein. The film 4 upon an application of power produces heat.

FIG. 1B illustrates a stencil 40 including stencil slits 42.

FIG. 10 illustrates the stencil 40 overlying a film 4 so that slits (not shown) can be cut in the film 4.

FIG. 1D illustrates a covering 60 being applied over the film 4 by a laminator 100. The heater includes slits 6 that were made into the heater using the stencil of FIG. 10.

FIG. 1E illustrates a plurality of heaters 2 including power application portions 80 applied to film 4. The film also includes slits 6.

FIG. 1F illustrates a heater 2 including a film 4, covering 60, and power application portions 80 and the flexibility of the heater 2 due to the inclusion of slits 6.

FIG. 1G is a thermal image of a heater 2. The slits 6 in the film 4 are low spots of heat and the power application portions 80 are visible on the film 4.

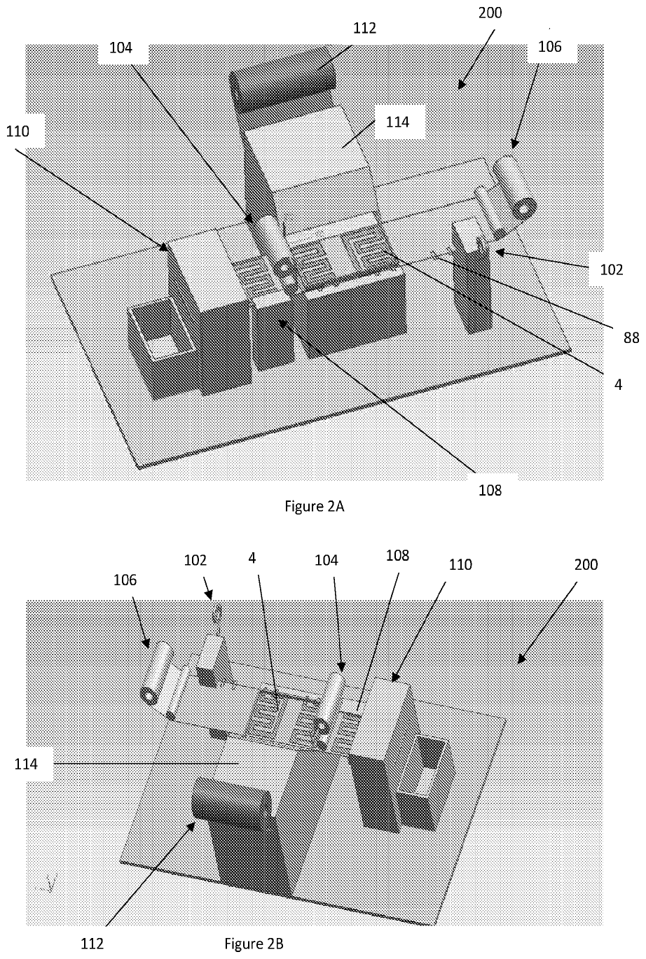

FIG. 2A is a front perspective view of a device 200 that produces the heater taught herein. The device 200 includes a lower covering 106 that extends in a machine direction past a tab applicator 102 that applies a tab 88 to the lower covering 106. The lower covering 106 extends under a film roll 112 that applies a film 4 to the lower covering 106. The film roll 112 extends through a press and/or slitter 114 that produces films 4 of a predetermined shape and configuration. The tabs 88 contact the film 4 so that upon an application of power the film 4 produces heat. An upper covering 104 applies a layer over the film 4 and finally the film 4 and covering extend pass a folder 108 and through a cutter 110.

FIG. 2B illustrate rear perspective view of the device 200. The device 200 includes a film roll 112 that extends a film 4 through a press and/or slitter where the film 4 is shaped, and then the film 4 extends between an upper covering 104 and a lower covering 106. The lower covering 106 extends past a tab applicator 102. The coverings and film 4 once combined, pass by a folder 108 and then through a cutter 110.

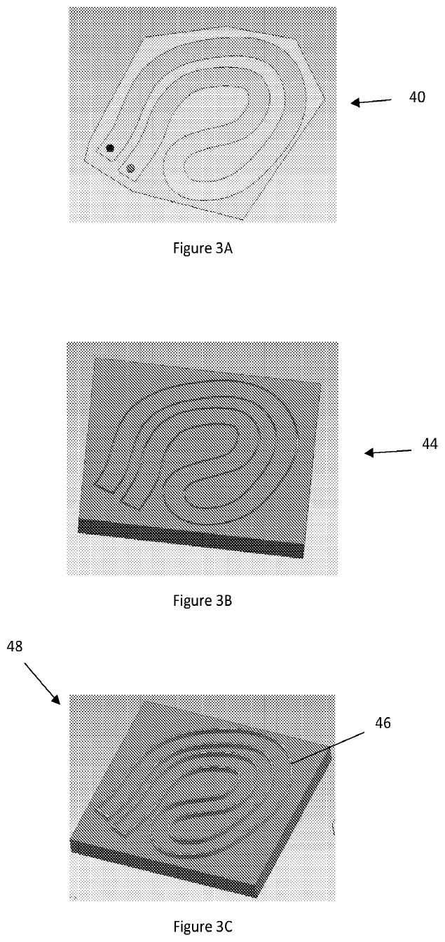

FIG. 3A illustrates a stencil 40 that will form die or a cutter with a predetermined shape.

FIG. 3Bz illustrates a die 44 having cavities formed using the stencil 40 of FIG. 3A.

FIG. 3C illustrates a blade 46 that extends into the cavities of FIG. 3C so that a cutter is formed based on the stencil of FIG. 3A.

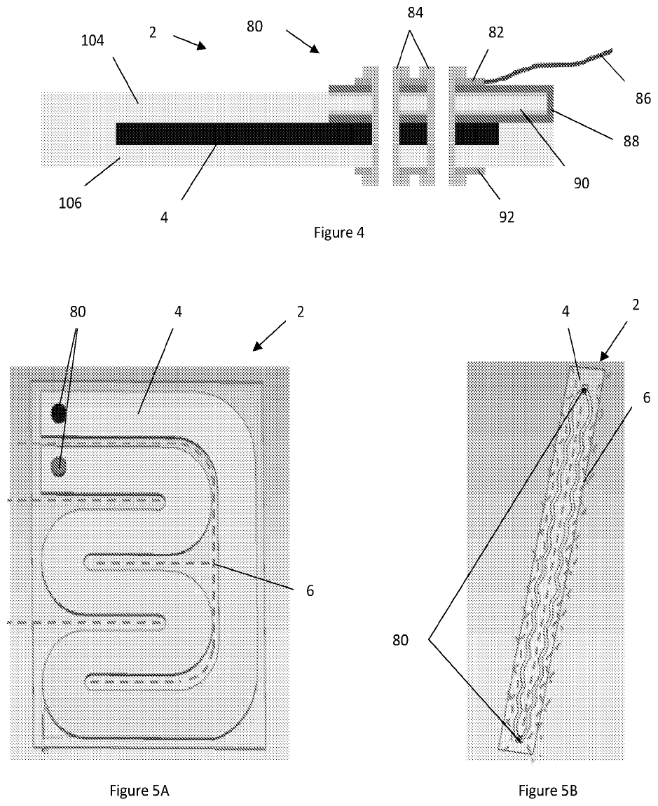

FIG. 4 illustrates a cross-sectional view of a heater 2 and power application portion 80. The heater 2 includes a film 4 located between an upper covering 104 and a lower covering 106. The power application portions include a rivet 84 that extends through the film 4, upper covering 104, and the lower covering 106. The rivets 84 include an upper terminal plate 82 that is connected to a wire 86. The upper terminal plate 82 is in contact with a tab 88 that is connected via an adhesive 90. On a bottom side of the rivet 84 there is a lower terminal plate 92.

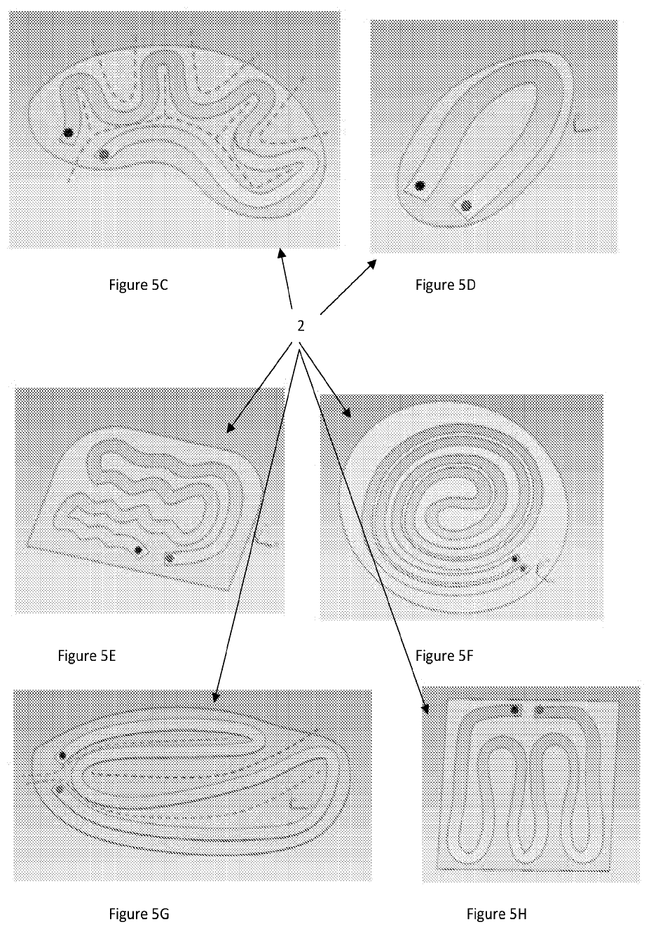

FIG. 5A is a heater 2 including a film 4 with slits 6 that provide flexibility and power application portions 80.

FIG. 5B is a heater 2 (i.e., steering wheel) including a film 4 with slits 6 that provide flexibility and have power application portions 80 at each end.

FIG. 5C illustrates a heater 2 for a bolster.

FIG. 5D illustrates a heater 2 for an armrest.

FIG. 5E illustrates a heater 2 for a headrest.

FIG. 5F illustrates a heater 2 for a shift knob.

FIG. 5G illustrates a heater 2 for a dashboard.

FIG. 5H illustrates a heater 2 for a door.

FIG. 5I illustrates a heater 2 for a ceiling.

FIG. 5J illustrates a heater 2 for a floor.

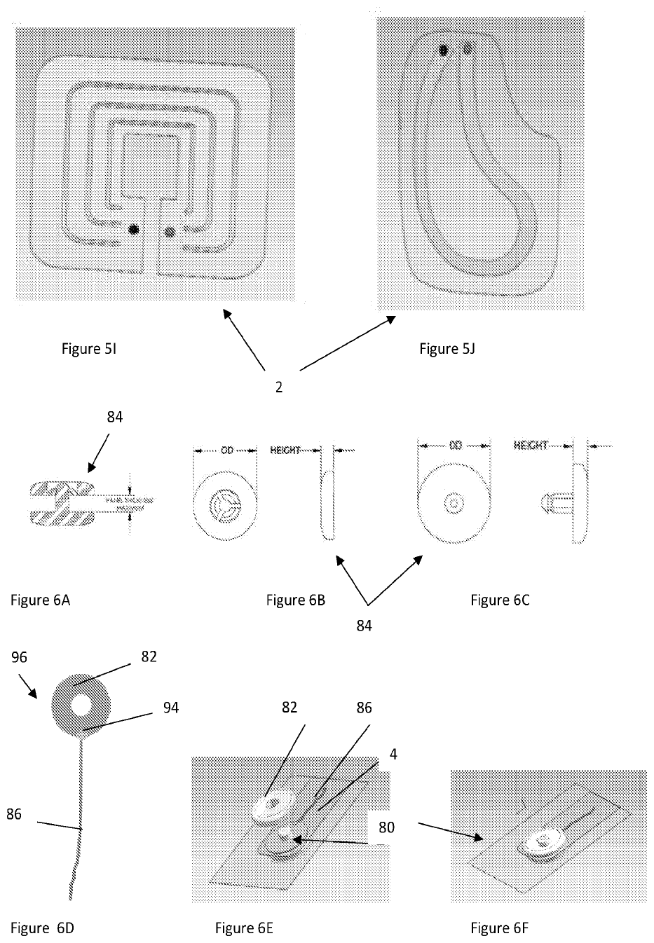

FIG. 6A is a cross-sectional view of a rivet 84.

FIG. 6B is a top view and a side view of a top of a rivet 84.

FIG. 6C is a top view and side view of a bottom of a rivet 84.

FIG. 6D is a top view of an attachment device 96 (upper terminal plate 82) that is connected to a wire 86 by a connection 94.

FIG. 6E is a power application portion 80 including an upper terminal plate 82 connected to the film 4.

FIG. 6F is a completed power application portion 80.

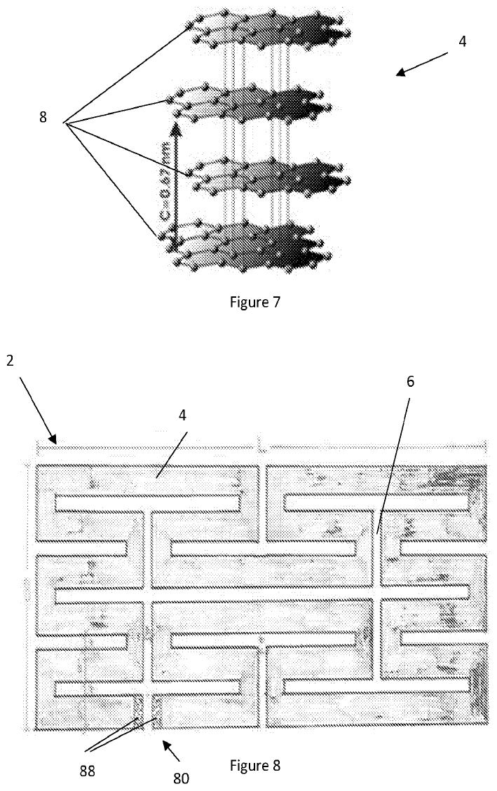

FIG. 7 illustrates the layers of atomic structure of the film 4.

FIG. 8 is a heater 2 including a film 4, slits between the film 4 and power application ports 80 with tabs 88 at ends of the film 4.

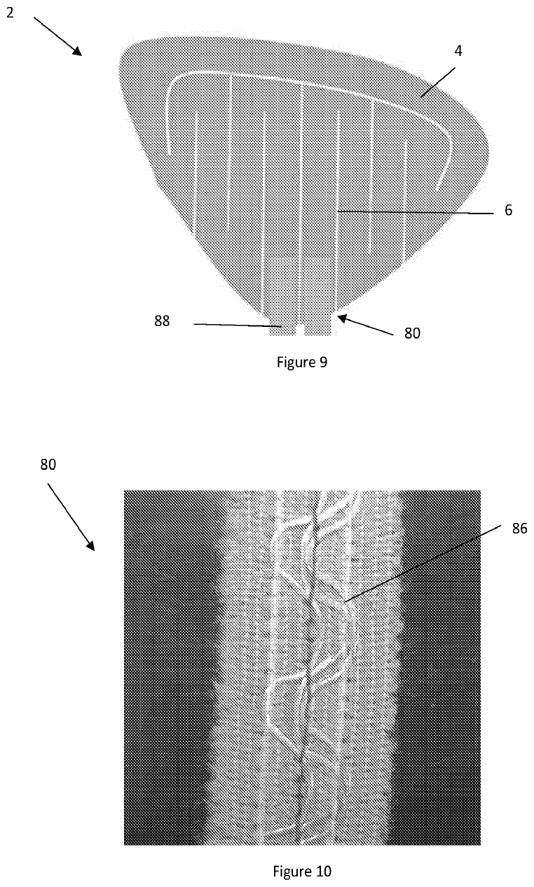

FIG. 9 is a heater 2 including a film 4 with slits 6 between portions of the film 6. Power application portions 80 and tabs 88 are connected to the film 4.

FIG. 10 are wires 86 of the power application portions 80.

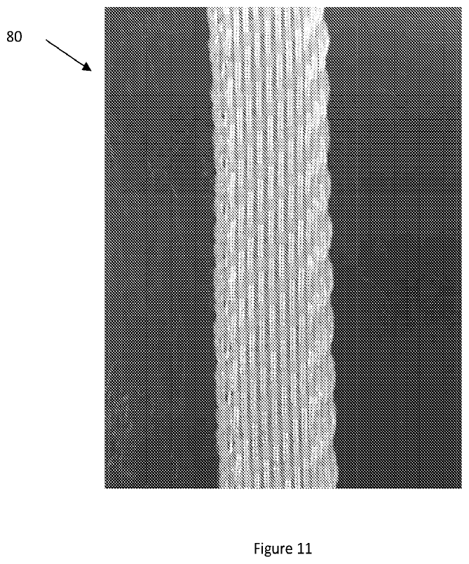

FIG. 11 illustrates a power application portions 80 that are woven.

Any numerical values recited herein include all values from the lower value to the upper value in increments of one unit provided that there is a separation of at least 2 units between any lower value and any higher value. As an example, if it is stated that the amount of a component or a value of a process variable such as, for example, temperature, pressure, time and the like is, for example, from 1 to 90, preferably from 20 to 80, more preferably from 30 to 70, it is intended that values such as 15 to 85, 22 to 68, 43 to 51, 30 to 32 etc. are expressly enumerated in this specification. For values which are less than one, one unit is considered to be 0.0001, 0.001, 0.01 or 0.1 as appropriate. These are only examples of what is specifically intended and all possible combinations of numerical values between the lowest value and the highest value enumerated are to be considered to be expressly stated in this application in a similar manner.

Unless otherwise stated, all ranges include both endpoints and all numbers between the endpoints. The use of “about” or “approximately” in connection with a range applies to both ends of the range. Thus, “about 20 to 30” is intended to cover “about 20 to about 30”, inclusive of at least the specified endpoints.

The disclosures of all articles and references, including patent applications and publications, are incorporated by reference for all purposes. The term “consisting essentially of” to describe a combination shall include the elements, ingredients, components or steps identified, and such other elements ingredients, components or steps that do not materially affect the basic and novel characteristics of the combination. The use of the terms “comprising” or “including” to describe combinations of elements, ingredients, components or steps herein also contemplates embodiments that consist essentially of the elements, ingredients, components or steps. By use of the term “may” herein, it is intended that any described attributes that “may” be included are optional.

Plural elements, ingredients, components or steps can be provided by a single integrated element, ingredient, component or step. Alternatively, a single integrated element, ingredient, component or step might be divided into separate plural elements, ingredients, components or steps. The disclosure of “a” or “one” to describe an element, ingredient, component or step is not intended to foreclose additional elements, ingredients, components or steps.

It is understood that the above description is intended to be illustrative and not restrictive. Many embodiments as well as many applications besides the examples provided will be apparent to those of skill in the art upon reading the above description. The scope of the teachings should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. The omission in the following claims of any aspect of subject matter that is disclosed herein is not a disclaimer of such subject matter, nor should it be regarded that the inventors did not consider such subject matter to be part of the disclosed inventive subject matter.
2 Heater
4 Film
6 Slits
8 Layers of atomic structure
40 Stencil
42 Stencil slits
44 Die
46 Blade
48 Cutter
60 Covering
80 Power application portion
82 Upper terminal plate
84 Rivet
86 Wire
88 Tab
90 Adhesive
92 Lower Terminal Plate
94 Connection
96 Attachment Device
100 Laminator
102 Tab applicator
104 Upper covering
106 Lower covering
108 Folder
110 Cutter
112 Film Roll
114 Press and slitter
200 Device

1) A heater comprising:
a. a film;
b. one or more coverings that extends along one or more sides of the film; and
c. one or more power application portions that apply power to the film so that the film heats up;
wherein the film includes about 70 percent by weight carbon or more and the film is in a form of a graphite film.

2) The heater of claim 1, wherein the graphite film has one or more layers.

3) The heater of claim 1, wherein the graphite film includes synthetic graphite or graphite formed through pyrolysis.

4) The heater of claim 1, wherein the graphite film has a thickness of about 0.25 mm or less, preferably about 0.20 mm or less, or more preferably about 0.15 mm or less.

5) The heater of claim 1, wherein the one or more coverings include one or more slits that extend at least partially along the film and the slits are sealed so that the film is sealed within the one or more coverings.

6) The heater of claim 1, wherein the power application portions include a tab that is in contact with the film.

7) The heater of claim 1, wherein the power application portions include an upper terminal plate that is connected to a wire and provides power to the power application portions.

8) The heater of claim 1, wherein the power application portions include one or more rivets that extend through the film, the one or more coverings, the tabs, or a combination thereof.

9) The heater of claim 1, wherein the one or more coverings extend along both sides of the film and the film is sandwiched between the one or more coverings, and the one or more coverings are sealed along edges so that the film is sealed within the one or more coverings.

10) The heater of claim 1, wherein the one or more coverings are made of plastic and are elastically deformable.

11) A method comprising:
a. forming a film by pressing carbon together,
b. connecting a covering to a first side of the film;
c. attaching one or more power application portions to the film;
d. folding a tab of the one or more power application portions from a first side of the film to a second side of the film so that a heater is formed;
e. cutting the film, the covering, or both;
wherein the carbon is in a form of a graphite film that when power is supplied heats up.

12) The method of claim 11, wherein the method includes a step of slitting the film, the covering, or both.

13) The method of claim 11, wherein the method includes a step of applying a covering to a second side of the film or folding the covering from the first side of the film to the second side of the film, and the covering on the first side and the covering on the second side are connected together.

14) The method of claim 11, wherein the method includes creating a cutter to cut the heater to a shape, add slits to the heater, or both.

15) The method of claim 14, wherein the cutter includes a die including cavities that hold a cutter and the cutter cuts the coverings, cuts slits in the coverings, or both.
